(19) United States
(12) Patent Application Publication
(10) Pub. No.: US 2025/0191840 A1
(43) Pub. Date: Jun. 12, 2025

(54) MULTILAYER CERAMIC CAPACITOR AND MULTILAYER CERAMIC CAPACITOR MOUNTING STRUCTURE

(71) Applicant: KYOCERA CORPORATION, Kyoto-shi, Kyoto (JP)

(72) Inventors: Tomohiro YANO, Kirishima-shi, Kagoshima (JP); Seiichi KOIZUMI, Aira-shi, Kagoshima (JP); Hidehumi IWASHITA, Seika-cho, Kotyo (JP)

(73) Assignee: KYOCERA CORPORATION, Kyoto-shi, Kyoto (JP)

(21) Appl. No.: 18/708,900

(22) PCT Filed: Jul. 21, 2022
(86) PCT No.: PCT/JP2022/028364

§ 371 Date: Nov. 20, 2024

(30) Foreign Application Priority Data
Nov. 18, 2021 (JP) 2021-188196

(51) Int. Cl. H01G 4/012; H01G 2/06; H01G 4/12

(52) U.S. Cl. CPC H01G 4/012; H01G 2/065; H01G 4/1209

(57) ABSTRACT

A multilayer ceramic capacitor includes a body, external electrodes, a first inspection electrode, and a second inspection electrode. The body includes a first internal electrode and a second internal electrode alternately stacked with a dielectric layer between the first internal electrode and the second internal electrode, and includes a first surface and a second surface, a first side surface and a second side surface, and a first end face and a second end face. The external electrodes are located on the first and second surfaces, and are connected to the first internal electrode. The external electrodes are located on the first and second surfaces, and are connected to the first internal electrode. The first inspection electrode and the second inspection electrode are located on the respective first end face and the second end face, and are connected to the respective first internal electrode and the second internal electrode.

### TECHNICAL FIELD

The present disclosure relates to a multilayer ceramic capacitor and a multilayer ceramic capacitor mounting structure.

### BACKGROUND OF INVENTION

Various multilayer ceramic capacitors with a small height appropriate for surface mounting on circuit boards have been proposed (refer to, for example, Patent Literature 1).

### CITATION LIST

### Patent Literature

Patent Literature 1: Japanese Unexamined Patent Application Publication No. 2001-155953

### SUMMARY

In an aspect of the present disclosure, a multilayer ceramic capacitor includes a body being substantially rectangular and including a first internal electrode and a second internal electrode alternately stacked in a first direction with a dielectric layer between the first internal electrode and the second internal electrode. The body includes a first surface and a second surface facing each other, a first side surface and a second side surface facing each other in the first direction, and a first end face and a second end face facing each other. The multilayer ceramic capacitor includes a first external electrode and a second external electrode located on the first surface, a third external electrode and a fourth external electrode located on the second surface, and a first inspection electrode located on the first end face and a second inspection electrode located on the second end face. The first internal electrode includes a first portion including a first extension, a second extension, and a first inspection extension. The second internal electrode includes a second portion including a third extension, a fourth extension, and a second inspection extension. The first extension extends to the first surface and is connected to the first external electrode. The second extension extends to the second surface and is connected to the third external electrode. The third extension extends to the first surface and is connected to the second external electrode. The fourth extension extends to the second surface and is connected to the fourth external electrode. The first inspection extension extends to the first end face and is connected to the first inspection electrode. The second inspection extension extends to the second end face and is connected to the second inspection electrode.

In another aspect of the present disclosure, a multilayer ceramic capacitor mounting structure includes the above multilayer ceramic capacitor, and a substrate including a mounting surface. The multilayer ceramic capacitor is mounted on the mounting surface with the first side surface perpendicular to the mounting surface.

### BRIEF DESCRIPTION OF THE DRAWINGS

The objects, features, and advantages of the present invention will become more apparent from the following detailed description and the drawings.

FIG. 1 is a perspective view of a multilayer ceramic capacitor according to an embodiment of the present disclosure.

FIG. 2 is an exploded perspective view of the multilayer ceramic capacitor according to the embodiment of the present disclosure.

FIG. 3 is a cross-sectional view taken along line III-III in FIG. 1.

FIG. 4 is a cross-sectional view taken along line IV-IV in FIG. 1.

FIG. 5 is a side view of the multilayer ceramic capacitor illustrated in FIG. 1 when viewed from a first side surface.

FIG. 6 is a side view of a mounting structure according to an embodiment of the present disclosure.

FIG. 7 is a cross-sectional view taken along line VII-VII in FIG. 6.

### DESCRIPTION OF EMBODIMENTS

A multilayer ceramic capacitor that forms the basis of a multilayer ceramic capacitor according to one or more embodiments of the present disclosure will be described first.

In the multilayer ceramic capacitor with the structure that forms the basis of the ceramic capacitor according to one or more embodiments of the present disclosure, external electrodes are located on the upper and lower surfaces of a low-profile body. Thus, probes of an electrical characteristic evaluation device cannot easily contact the external electrodes in a reliable manner when characteristics such as capacitance and insulation resistance are evaluated. This may cause difficulty in determining whether a multilayer ceramic capacitor is acceptable or defective accurately to manufacture highly reliable multilayer ceramic capacitors efficiently.

A multilayer ceramic capacitor and a mounting structure in one or more embodiments of the present disclosure will now be described with reference to the drawings. The figures referred to below are schematic, and may not be drawn to scale relative to, for example, the actual dimensional ratios. An orthogonal XYZ coordinate system is defined herein for ease of explanation.

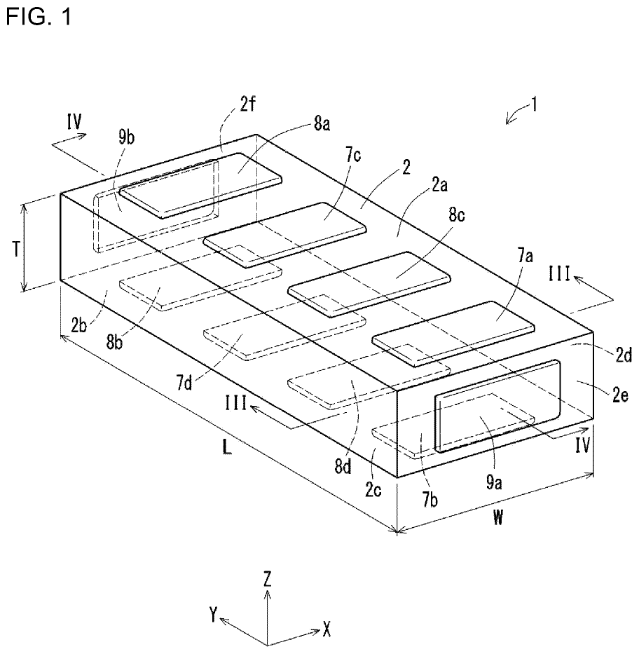

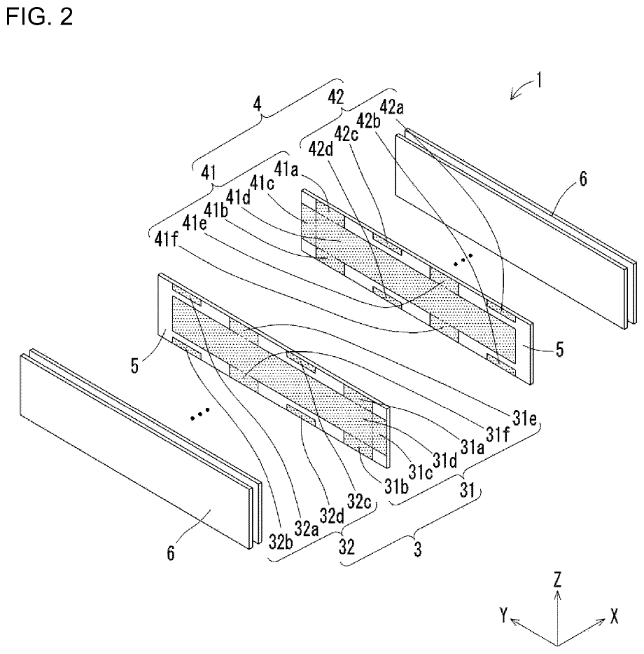

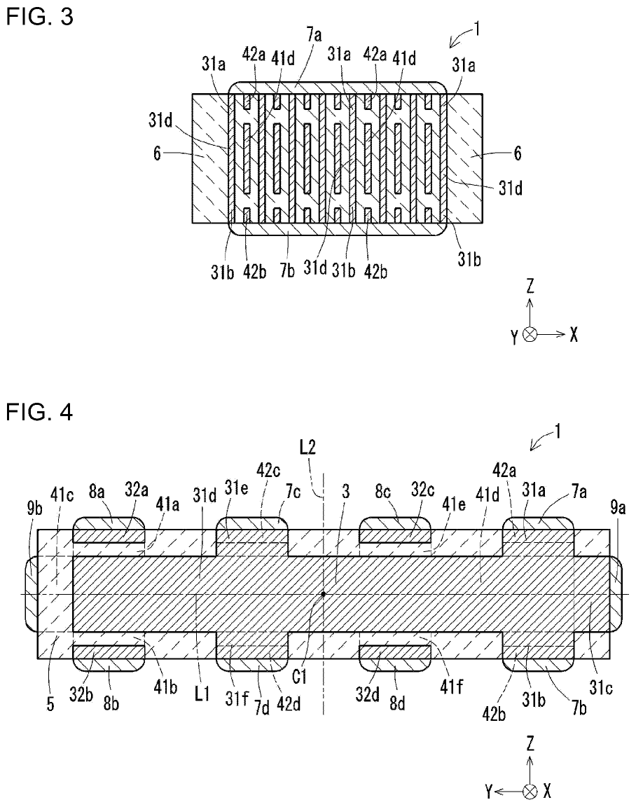

FIG. 1 is a perspective view of a multilayer ceramic capacitor according to an embodiment of the present disclosure. FIG. 2 is an exploded perspective view of the multilayer ceramic capacitor according to the embodiment of the present disclosure. FIG. 3 is a cross-sectional view taken along line III-III in FIG. 1. FIG. 4 is a cross-sectional view taken along line IV-IV in FIG. 1. In FIG. 1, internal electrodes located inside a body are not illustrated. In FIG. 2, external electrodes located on surfaces of the body are not illustrated. FIG. 3 illustrates a cross section taken along a line parallel to a first end face and a second end face. FIG. 4 illustrates a cross section taken along a line parallel to a first side surface and a second side surface.

In the present embodiment, a multilayer ceramic capacitor 1 includes a body 2, a first external electrode 7a, a second external electrode 8a, a third external electrode 7b, a fourth external electrode 8b, a first inspection electrode 9a, and a second inspection electrode 9b. Hereafter, the first external electrode 7a, the second external electrode 8a, the third external electrode 7b, and the fourth external electrode 8b may be collectively referred to as external electrodes 7 and 8. The first inspection electrode 9a and the second inspection electrode 9b may be collectively referred to as inspection electrodes 9.

The body 2 includes first internal electrodes 3, second internal electrodes 4, and dielectric layers 5. The first internal electrodes 3 and the second internal electrodes 4 are stacked alternately in a first direction (X-direction in FIGS. 1 and 2) with the dielectric layers 5 between them, as illustrated in FIG. 2. Hereafter, the first internal electrodes 3 and the second internal electrodes 4 may be collectively referred to as internal electrodes 3 and 4.

The first internal electrodes 3 and the second internal electrodes 4 are made of a conductive material. The first internal electrodes 3 and the second internal electrodes 4 may be made of, for example, a metal such as nickel (Ni), copper (Cu), silver (Ag), tin (Sn), platinum (Pt), palladium (Pd), or gold (Au), or an alloy containing any of these metals.

The dielectric layers 5 are made of an insulating material. The dielectric layers 5 may contain a dielectric material (ceramic material) such as barium titanate (BaTiO₃), calcium titanate (CaTiO₃), strontium titanate (SrTiO₃), or barium zirconate (BaZrO₃) as a main component. The main component herein refers to the component with the highest concentration (mol %) in the material or member of interest.

The main component of the dielectric layers 5 may be a high dielectric constant material. The high dielectric constant material may be, for example, a perovskite ferroelectric material containing any of the above dielectric materials. The dielectric layer 5 may contain a rare earth element, such as yttrium (Y), dysprosium (Dy), holmium (Ho), terbium gadolinium (Gd), or terbium (Tb).

As illustrated in FIG. 1, the body 2 is substantially rectangular and includes a first surface 2a and a second surface 2b facing each other, a first side surface 2c and a second side surface 2d facing each other, and a first end face 2e and a second end face 2f facing each other. The first side surface 2c and the second side surface 2d are perpendicular to the first direction (X-direction) and face each other in the first direction. The first end face 2e and the second end face 2f are perpendicular to a second direction (Y-direction) and face each other in the second direction. The first surface 2a and the second surface 2b are perpendicular to a third direction (Z-direction) and face each other in the third direction. The first direction may also be referred to as a stacking direction or a height direction. The second direction may also be referred to as a length direction, and the third direction as a height direction. The first side surface 2c and the second side surface 2d may also be collectively referred to as side surfaces 2c and 2d. The first end face 2e and the second end face 2f may also be collectively referred to as end faces 2e and 2f.

The side surfaces 2c and 2d of the body 2 are the surfaces of side covers 6, as illustrated in FIG. 2. This structure protects the first internal electrodes 3 and the second internal electrodes 4 from the external environment. The side covers 6 may each include one or more dielectric layers. The dielectric layers in the side covers 6 may have the same composition, dimensions, and other features as the dielectric layers 5.

Each first internal electrode 3 includes first portions 31 as illustrated in FIG. 2. The first portions 31 include a first extension 31a, a second extension 31b, and a first inspection extension 31c. The first extension 31a extends to the first surface 2a, and the second extension 31b extends to the second surface 2b. The first inspection extension 31c extends to the first end face 2e.

The first portions 31 include a first capacitance portion 31d as illustrated in FIG. 2. The first extension 31a, the second extension 31b, and the first inspection extension 31c extend from the first capacitance portion 31d.

Each second internal electrode 4 includes second portions 41 as illustrated in FIG. 2. The second portions 41 include a third extension 41a, a fourth extension 41b, and a second inspection extension 41c. The third extension 41a extends to the first surface 2a, and the fourth extension 41b extends to the second surface 2b. The second inspection extension 41c extends to the second end face 2f.

The second portions 41 include a second capacitance portion 41d as illustrated in FIG. 2. The third extension 41a, the fourth extension 41b, and the second inspection extension 41c extend from the second capacitance portion 41d. The first capacitance portion 31d and the second capacitance portion 41d overlap each other when viewed in the first direction (stacking direction). A potential difference between the first capacitance portion 31d and the second capacitance portion 41d generates a capacitance in the dielectric layer 5 located between the first capacitance portion 31d and the second capacitance portion 41d.

The first external electrode 7a and the second external electrode 8a are located on the first surface 2a. As illustrated in FIG. 3, the first external electrode 7a connects multiple first extensions 31a with one another. The first external electrode 7a covers the multiple first extensions 31a. The second external electrode 8a connects multiple third extensions 41a with one another in the same or similar manner as the first external electrode 7a illustrated in FIG. 3. The second external electrode 8a covers the multiple third extensions 41a.

The third external electrode 7b and the fourth external electrode 8b are located on the second surface 2b. As illustrated in FIG. 3, the third external electrode 7b connects multiple second extensions 31b with one another. The third external electrode 7b covers the multiple second extensions 31b. The fourth external electrode 8b connects multiple fourth extensions 41b with one another in the same or similar manner as the third external electrode 7b illustrated in FIG. 3. The fourth external electrode 8b covers the multiple fourth extensions 41b.

The external electrodes 7 and 8 may each include one or more conductive layers. A first conductive layer in contact with the first surface 2a and the second surface 2b (specifically, surfaces connected to the internal electrodes 3 and 4) may be formed using, for example, a thin film deposition technique such as plating, sputtering, or vapor deposition, or a thick film deposition technique such as screen printing or gravure printing. Layers on the first conductive layer, such as a second conductive layer and a third conductive layer, may be formed using a thin film deposition technique such as electroplating. The first conductive layer may be made of, for example, a metal such as Ni, Cu, Ag, Pd, or Au, or an alloy containing any of these metals. The second conductive layer, the third conductive layer, and any other conductive layers may be made of, for example, a metal such as Ni, Cu, Au, or Sn.

The first inspection electrode 9a is located on the first end face 2e. The first inspection electrode 9a connects multiple first inspection extensions 31c with one another. The first inspection electrode 9a covers the multiple first inspection extensions 31c. The second inspection electrode 9b is located on the second end face 2f. The second inspection electrode 9b connects multiple second inspection extensions 41c with one another. The second inspection electrode 9b covers the multiple second inspection extensions 41c. The inspection electrodes 9 may each include one or more conductive layers in the same or similar manner as the external electrodes 7 and 8.

In the present embodiment, the multilayer ceramic capacitor 1 includes the inspection electrodes 9 separate from the external electrodes 7 and 8. The inspection electrodes 9 are located on the end faces 2e and 2f on which none of the external electrode 7 or 8 is located. Thus, two probes of an inspection device can easily contact the first inspection electrode 9a and the second inspection electrode 9b although the height of the body 2 is reduced (specifically, the dimension between the first surface 2a and the second surface 2b is reduced). The probes of the electrical characteristic evaluation device can thus be in contact with the external electrodes in a reliable manner. This allows accurate determination as to whether the multilayer ceramic capacitor is acceptable or defective, thus allowing efficient production of highly reliable multilayer ceramic capacitors.

The first internal electrodes 3 may each include a set of first dummy portions 32 that are electrically isolated from the first portions 31. Each set of the first dummy portions 32 may include a first dummy extension 32a and a second dummy extension 32b.

The first dummy extension 32a may extend to the first surface 2a. The first dummy extension 32a may be connected to the second external electrode 8a. This increases the strength of connection between the body 2 and the second external electrode 8a, thus increasing the reliability of electrical connection between each second internal electrode 4 and the second external electrode 8a.

The second dummy extension 32b may extend to the second surface 2b. The second dummy extension 32b may be connected to the fourth external electrode 8b. This increases the strength of connection between the body 2 and the fourth external electrode 8b, thus increasing the reliability of electrical connection between each second internal electrode 4 and the fourth external electrode 8b.

The first dummy extension 32a may overlap the third extension 41a when viewed in the stacking direction (X-direction). Thus, the second external electrode 8a can be rectangular with its length in the first direction (X-direction) and its width smaller in the second direction (Y-direction), as illustrated in FIG. 1. This facilitates formation of the second external electrode 8a and reduces the likelihood of a leakage current between the second external electrode 8a and another external electrode different in polarity from the second external electrode 8a.

The second dummy extension 32b may overlap the fourth extension 41b when viewed in the stacking direction (X-direction). Thus, the fourth external electrode 8b can be rectangular with its length in the first direction (X-direction) and its width smaller in the second direction (Y-direction), as illustrated in FIG. 1. This facilitates formation of the fourth external electrode 8b. This also reduces the likelihood of a leakage current between the fourth external electrode 8b and another external electrode different in polarity from the fourth external electrode 8b.

The second internal electrodes 4 may each include a set of second dummy portions 42 electrically isolated from the second portions 41. Each set of the second dummy portions 42 may include a third dummy extension 42a and a fourth dummy extension 42b.

The third dummy extension 42a may extend to the first surface 2a. The third dummy extension 42a may be connected to the first external electrode 7a. This increases the strength of connection between the body 2 and the first external electrode 7a, thus increasing the reliability of electrical connection between each first internal electrode 3 and the first external electrode 7a.

The fourth dummy extension 42b may extend to the second surface 2b. The fourth dummy extension 42b may be connected to the third external electrode 7b. This increases the strength of connection between the body 2 and the third external electrode 7b, thus increasing the reliability of electrical connection between each first internal electrode 3 and the third external electrode 7b.

The third dummy extension 42a may overlap the first extension 31a when viewed in the stacking direction (X-direction). Thus, the first external electrode 7a can be rectangular with its length in the first direction (X-direction) and its width smaller in the second direction (Y-direction), as illustrated in FIG. 1. This facilitates formation of the first external electrode 7a. This also reduces the likelihood of a leakage current between the first external electrode 7a and another external electrode different in polarity from the first external electrode 7a.

The fourth dummy extension 42b may overlap the second extension 31b when viewed in the stacking direction (X-direction). Thus, the third external electrode 7b can be rectangular with its length in the first direction (X-direction) and its width smaller in the second direction (Y-direction), as illustrated in FIG. 1. This facilitates formation of the third external electrode 7b. This also reduces the likelihood of a leakage current between the third external electrode 7b and another external electrode different in polarity from the third external electrode 7b.

The first external electrode 7a and the third external electrode 7b may be located adjacent to the first end face 2e. This reduces the likelihood of a leakage current between the first external electrode 7a and the second inspection electrode 9b different in polarity from the first external electrode 7a, as well as between the third external electrode 7b and the second inspection electrode 9b different in polarity from the third external electrode 7b.

The second external electrode 8a and the fourth external electrode 8b may be located adjacent to the second end face 2f. This reduces the likelihood of a leakage current between the second external electrode 8a and the first inspection electrode 9a different in polarity from the second external electrode 8a, as well as between the fourth external electrode 8b and the first inspection electrode 9a different in polarity from the fourth external electrode 8b.

When viewed in a direction perpendicular to the first surface 2a, the first external electrode 7a and the third external electrode 7b may overlap, and the second external electrode 8a and the fourth external electrode 8b may overlap. In this case, as illustrated in FIG. 4, each of the first internal electrodes 3 and the second internal electrodes 4 is symmetric with respect to a line L1 extending in the longitudinal direction (Y-direction) through centroids C1 of the side surfaces 2c and 2d. This reduces warpage of the body 2 due to the difference in firing shrinkage between the metal or alloy material for the internal electrodes 3 and 4 and the ceramic material for the dielectric layers 5 in fabricating the body 2. This increases the reliability of the connection between the multilayer ceramic capacitor 1 and an external substrate.

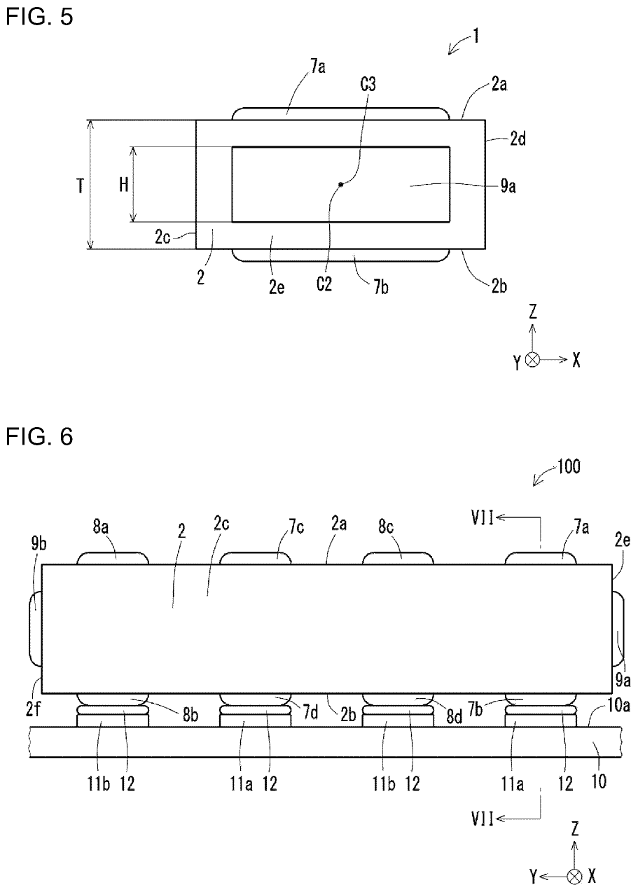

The inspection electrodes 9 may each have, in the height direction (Z-direction), an effective height H of 30 to 90% inclusive of a height T (specifically, the distance between the first surface 2a and the second surface 2b) of the body 2 (refer to FIG. 5). The effective height H being less than 30% of the height T may cause difficulty in placing the probes of the electrical characteristic evaluation device in contact with the inspection electrodes 9. The effective height H greater than 90% of the height T may cause a leakage current between the inspection electrodes 9 and the external electrodes 7 or between the inspection electrodes 9 and the external electrodes 8, causing inaccurate evaluation of the characteristics such as capacitance and insulation resistance. The effective height H being 30 to 90% of the height T allows easy and accurate evaluation of the electrical characteristics of the multilayer ceramic capacitor 1. The effective height H being less than or equal to 80% of the height T reduces the likelihood of misalignment in cutting that can lower the production yield of stacks before firing. The effective height H being less than or equal to 70% of the height T reduces the likelihood of delamination after firing caused by bonding at margins.

In the multilayer ceramic capacitor 1, as illustrated in FIG. 5, centroids C2 of the inspection electrodes 9 and the centroids C3 of the end faces 2e and 2f may be substantially aligned when viewed in the longitudinal direction (Y-direction). In this case, the probes of the electrical characteristic evaluation device can be placed in contact with the inspection electrodes 9 more easily, thus allowing more accurate evaluation of the electrical characteristics of the multilayer ceramic capacitor 1.

The multilayer ceramic capacitor 1 may further include a fifth external electrode 7c and a sixth external electrode 8c located on the first surface 2a, and a seventh external electrode 7d and an eighth external electrode 8d located on the second surface 2b, as illustrated in FIG. 1. The first portions 31 of each first internal electrode 3 may further include a fifth extension 31e extending to the first surface 2a and a sixth extension 31f extending to the second surface 2b, as illustrated in FIG. 2. The second portions 41 of each second internal electrode 4 may further include a seventh extension 41e extending to the first surface 2a and an eighth extension 41f extending to the second surface 2b, as illustrated in FIG. 2. The fifth extension 31e may be connected to the fifth external electrode 7c, and the sixth extension 31f may be connected to the seventh external electrode 7d. The seventh extension 41e may be connected to the sixth external electrode 8c, and the eighth extension 41f may be connected to the eighth external electrode 8d. The multilayer ceramic capacitor 1 further including the fifth external electrode 7c, the sixth external electrode 8c, the seventh external electrode 7d, and the eighth external electrode 8d increases flexibility in connection between the multilayer ceramic capacitor 1 and an external substrate.

The first dummy portions 32 of each first internal electrode 3 may further include a fifth dummy extension 32c extending to the first surface 2a and a sixth dummy extension 32d extending to the second surface 2b. The fifth dummy extension 32c may be connected to the sixth external electrode 8c, and the sixth dummy extension 32d may be connected to the eighth external electrode 8d. This increases the strength of connection between the body 2 and the sixth external electrode 8c, as well as between the body 2 and the eighth external electrode 8d, thus increasing the reliability of electrical connection between each second internal electrode 4 and the sixth external electrode 8c, as well as between each second internal electrode 4 and the eighth external electrode 8d. The fifth dummy extension 32c may overlap the seventh extension 41e, and the sixth dummy extension 32d may overlap the eighth extension 41f when viewed in the stacking direction (X-direction). This facilitates formation of the sixth external electrode 8c and the eighth external electrode 8d and reduces the likelihood of a leakage current between the sixth external electrode 8c and another external electrode different in polarity from the sixth external electrode 8c, as well as between the eighth external electrode 8d and another external electrode different in polarity from the eighth external electrode 8d.

The second dummy portions 42 of each second internal electrode 4 may further include a seventh dummy extension 42c extending to the first surface 2a and an eighth dummy extension 42d extending to the second surface 2b. The seventh dummy extension 42c may be connected to the fifth external electrode 7c, and the eighth dummy extension 42d may be connected to the seventh external electrode 7d. This increases the strength of connection between the body 2 and the fifth external electrode 7c, as well as between the body 2 and the seventh external electrode 7d, thus increasing the reliability of electrical connection between each first internal electrode 3 and the fifth external electrode 7c, as well as between each first internal electrode 3 and the seventh external electrode 7d. The seventh dummy extension 42c may overlap the fifth extensions 31e, and the eighth dummy extensions 42d may overlap the seventh extensions 41e when viewed in the stacking direction (X-direction). This facilitates formation of the fifth external electrode 7c and the seventh external electrode 7d and reduces the likelihood of a leakage current between the fifth external electrode 7c and another external electrode different in polarity from the fifth external electrode 7c, as well as between the seventh external electrode 7d and another external electrode different in polarity from the seventh external electrode 7d.

The second internal electrodes 4 may be in the shape of the first internal electrode 3 reversed with respect to a straight line L2 extending through the centroids C1 of the side surfaces 2c and 2d in the height direction (Z-direction), as illustrated in FIG. 4. Thus, in fabricating the body 2, ceramic green sheets with printed electrode patterns to be the internal electrodes 3 and 4 can be formed efficiently.

A method for manufacturing the multilayer ceramic capacitor 1 will now be described.

First, as a material for the dielectric layers 5, a powder containing a dielectric material such as BaTiO₃, CaTiO₃, or SrTiO₃, or a mixture of these as a main component is prepared, and an organic vehicle is added to the powder to prepare ceramic slurry. Then, ceramic green sheets (hereafter simply referred to as green sheets) are fabricated using, for example, doctor blading or die coating. Each green sheet may have a thickness of, for example, about 0.5 to 10 μm.

A conductive paste is then prepared as the material for the first internal electrodes 3 and the second internal electrodes 4 using a powder containing a metal such as Ni, Cu, or Ag, or a mixture of these as a main component. Using the prepared conductive paste, a first pattern sheet that is a green sheet with an electrode pattern to be the first internal electrodes 3 printed on its main surface and a second pattern sheet that is a green sheet with an electrode pattern to be the second internal electrodes 4 printed on its main surface are formed. The electrode patterns may be printed by, for example, screen printing or gravure printing.

A predetermined number of the first pattern sheets and a predetermined number of the second pattern sheets are then alternately stacked on a stack of a predetermined number of ceramic green sheets, and a predetermined number of ceramic green sheets are stacked on the stack of the first pattern sheets and the second pattern sheets to fabricate a temporary stack. The temporary stack is then pressed in the stacking direction to obtain a multilayer base. The stack may be pressed using, for example, a hydrostatic press device. The multilayer base is cut at intended positions to obtain a base component to be the body 2. Subsequently, the base component is degreased in an ambient atmosphere, an inert gas atmosphere, or a reducing atmosphere, and then fired in a reducing atmosphere. The firing temperature may be, for example, 1100 to 1300° C. The base component is then reoxidized in a nitrogen atmosphere. The reoxidized base component is placed in a pot with an abrasive powder or abrasive media, and the pot is rotated to round corners and deburrs the base component for polishing to obtain the body 2.

The external electrodes 7 and 8 are formed on the first surface 2a and the second surface 2b of the resulting body 2, the first inspection electrode 9a is formed on the first end face 2e, and the second inspection electrode 9b is formed on the second end face 2f to fabricate the multilayer ceramic capacitor 1. The external electrodes 7 and 8 and the inspection electrodes 9 can be formed using a thin-film deposition technique or a thick-film deposition technique described above.

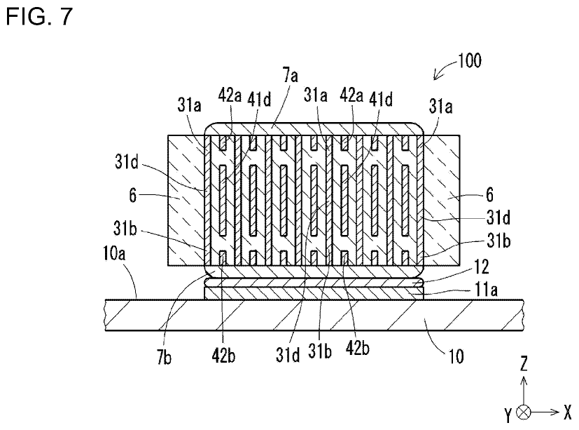

A mounting structure according to an embodiment of the present disclosure will now be described. FIG. 6 is a side view of the mounting structure according to the embodiment of the present disclosure. FIG. 7 is a cross-sectional view taken along line VII-VII in FIG. 6.

In the present embodiment, a mounting structure 100 includes a multilayer ceramic capacitor 1 and a substrate 10. The substrate 10 includes a mounting surface 10a. The substrate 10 includes at least one first substrate electrode 11a and at least one second substrate electrode 11b located on the mounting surface 10a as illustrated in FIG. 6. An electrical circuit electrically connected to the multilayer ceramic capacitor 1 may be located on the mounting surface 10a.

The multilayer ceramic capacitor 1 is mounted on the mounting surface 10a with the side surfaces 2c and 2d perpendicular to the mounting surface 10a. In other words, as illustrated in FIG. 7, the multilayer ceramic capacitor 1 is mounted on the mounting surface 10a with the first internal electrodes 3 and the second internal electrodes 4 perpendicular to the mounting surface 10a.

In the multilayer ceramic capacitor 1, at least one of the first external electrode 7a, the third external electrode 7b, the fifth external electrode 7c, or the seventh external electrode 7d may be electrically connected to the corresponding substrate electrode 11a, and at least one of the second external electrode 8a, the fourth external electrode 8b, the sixth external electrode 8c, or the eighth external electrode 8d may be electrically connected to the corresponding second substrate electrode 11b. The multilayer ceramic capacitor 1 may be mounted on the substrate 10 by, for example, bonding the first external electrode 7a to the first substrate electrode 11a and the second external electrode 8a to the second substrate electrode 11b, each with a conductive bond 12. The conductive bond 12 may be, for example, a solder material or a brazing material.

The multilayer ceramic capacitor 1 may be mounted on the substrate 10 by, for example, electrically connecting the first external electrode 7a to one of two first substrate electrodes 11a and the third external electrode 7b to the other of the two first substrate electrodes 11a, and electrically connecting the second external electrode 8a to one of two second substrate electrodes 11b and the fourth external electrode 8b to the other of the two second substrate electrodes 11b. In this case, the first external electrode 7a may be bonded to the first substrate electrode 11a and the second external electrode 8a may be bonded to the second substrate electrode 11b, each with the conductive bond 12. The third external electrode 7b may be bonded to the first substrate electrode 11a and the fourth external electrode 8b may be bonded to the second substrate electrode 11b, each with a connector such as a bonding wire.

The multilayer ceramic capacitor 1 including the first external electrode 7a, the second external electrode 8a, the fifth external electrode 7c, and the sixth external electrode 8c may be mounted on the mounting surface 10a, as illustrated in FIG. 6, by bonding the first external electrode 7a to one of two first substrate electrodes 11a and the fifth external electrode 7c to the other of the two first substrate electrodes 11a, and by bonding the second external electrode 8a to one of two second substrate electrodes 11b and the sixth external electrode 8c to the other of the two second substrate electrodes 11b. In this case, at least one of the third external electrode 7b or the fifth external electrode 7c may be electrically connected to the other first substrate electrode 11a with a connector. In addition, at least one of the fourth external electrode 8c or the sixth external electrode 8d may be electrically connected to the other second substrate electrode 11b with a connector.

The mounting structure 100 including the multilayer ceramic capacitor 1 thus has high reliability.

### EXAMPLE

A large number of multilayer ceramic capacitors 1 illustrated in FIGS. 1 to 4 were manufactured in an example. The body 2 was a stack of 800 dielectric layers 5 with a thickness of 1.2±0.1 μm, a height T (distance between the first surface 2a and the second surface 2b) of 0.6±0.1 mm, a width W (distance between the first side surface 2c and the second side surface 2d) of 2.0±0.2 mm, and a length L (distance between the first end face 2e and the second end face 2f) of 4.0±0.2 mm. For the large number of multilayer ceramic capacitors 1, the capacitance and the leakage current were measured using an electrical characteristic evaluation device. The values within a tolerance of ±15% in characteristics and with a deviation from the average leakage current within ±3σ (σ is the standard deviation) when the leakage current is assumed to be distributed normally were determined to be acceptable.

A large number of multilayer ceramic capacitors in a comparative example were manufactured in the same or similar manner as in the example except that the structure in the comparative example included none of the inspection electrode 9, the first inspection extension 31c, or the second inspection extension 41c. The capacitance of the multilayer ceramic capacitors in the comparative example was measured manually using an LCR meter, and the values within a tolerance of ±15% in characteristics were determined to be acceptable.

The cross sections of 100 acceptable products of the multilayer ceramic capacitor in the example and 100 acceptable products of the multilayer ceramic capacitor in the comparative example were inspected for internal defects by visual observation. As a result, no internal defects were found in the 100 acceptable products of the multilayer ceramic capacitor in the example, but internal defects were found in five of the 100 acceptable products of the multilayer ceramic capacitor in the comparison example. This reveals that the structure of the multilayer ceramic capacitor in the example including the inspection electrodes 9 allows accurate determination as to whether each product is acceptable or defective. The multilayer ceramic capacitor 1 according to one or more embodiments of the present disclosure thus can be efficiently manufactured with high reliability.

The multilayer ceramic capacitor according to one or more embodiments of the present disclosure may be implemented in forms 1 to 7 described below.
(1) A multilayer ceramic capacitor, comprising:
a body being substantially rectangular and including a first internal electrode and a second internal electrode alternately stacked in a first direction with a dielectric layer between the first internal electrode and the second internal electrode, the body including a first surface and a second surface facing each other, a first side surface and a second side surface facing each other in the first direction, and a first end face and a second end face facing each other;
a first external electrode and a second external electrode located on the first surface;
a third external electrode and a fourth external electrode located on the second surface; and
a first inspection electrode located on the first end face and a second inspection electrode located on the second end face,
wherein the first internal electrode includes a first portion including a first extension, a second extension, and a first inspection extension,
the second internal electrode includes a second portion including a third extension, a fourth extension, and a second inspection extension,
the first extension extends to the first surface and is connected to the first external electrode, and the second extension extends to the second surface and is connected to the third external electrode,
the third extension extends to the first surface and is connected to the second external electrode, and the fourth extension extends to the second surface and is connected to the fourth external electrode, and
the first inspection extension extends to the first end face and is connected to the first inspection electrode, and the second inspection extension extends to the second end face and is connected to the second inspection electrode.
(2) The multilayer ceramic capacitor according to (1), wherein
the first internal electrode further includes a first dummy portion electrically isolated from the first portion,
the second internal electrode further includes a second dummy portion electrically isolated from the second portion,
the first dummy portion includes a first dummy extension extending to the first surface and a second dummy extension extending to the second surface,
the second dummy portion further includes a third dummy extension extending to the first surface and a fourth dummy extension extending to the second surface,
the first dummy extension is connected to the second external electrode, and the second dummy extension is connected to the fourth external electrode, and
the third dummy extension is connected to the first external electrode, and the fourth dummy extension is connected to the second external electrode.
(3) The multilayer ceramic capacitor according to (2), wherein
when viewed in a direction perpendicular to the first side surface, the first extension and the third dummy extension overlap, and the second extension and the fourth dummy extension overlap.
(4) The multilayer ceramic capacitor according to (2) or (3), wherein
when viewed in a direction perpendicular to the first side surface, the third extension and the first dummy extension overlap, and the fourth extension and the second dummy extension overlap.
(5) The multilayer ceramic capacitor according to any one of (1) to (4), wherein
the first external electrode and the third external electrode are located adjacent to the first end face, and the second external electrode and the fourth external electrode are located adjacent to the second end face.
(6) The multilayer ceramic capacitor according to any one of (1) to (5), wherein
when viewed in a direction perpendicular to the first side surface, the first external electrode and the third external electrode overlap, and the second external electrode and the fourth external electrode overlap.
(7) The multilayer ceramic capacitor according to any one of (1) to (6), wherein
the first inspection electrode and the second inspection electrode each have, in a direction perpendicular to the first surface, a dimension of 30 to 90% inclusive of a distance between the first surface and the second surface.

The mounting structure according to one or more embodiments of the present disclosure may be implemented in forms 8 and 9 described below.
(8) A multilayer ceramic capacitor mounting structure, comprising:
the multilayer ceramic capacitor according to any one of (1) to (7); and
a substrate including a mounting surface,
wherein the multilayer ceramic capacitor is mounted on the mounting surface with the first side surface perpendicular to the mounting surface.
(9) The multilayer ceramic capacitor mounting structure according to (8), wherein
the substrate includes a first substrate electrode and a second substrate electrode located on the mounting surface, and
the first external electrode in the multilayer ceramic capacitor is bonded to the first substrate electrode with a conductive bond, and the second external electrode in the multilayer ceramic capacitor is bonded to the second substrate electrode with a conductive bond.

The multilayer ceramic capacitor according to one or more embodiments of the present disclosure can be efficiently manufactured with high reliability. The mounting structure according to one or more embodiments of the present disclosure including the multilayer ceramic capacitor described above thus has high reliability.

Although embodiments of the present disclosure have been described in detail, the present disclosure is not limited to the embodiments, and may be changed or varied in various manners without departing from the spirit and scope of the present disclosure.

The present disclosure may be embodied in various forms without departing from the spirit or the main features of the present disclosure. The embodiments described above are thus merely illustrative in all respects. The scope of the present disclosure is defined not by the description given above but by the claims. Any modifications and alterations contained in the claims fall within the scope of the present disclosure.

### REFERENCE SIGNS

1 multilayer ceramic capacitor
2 body
2a first surface
2b second surface
2c first side surface
2d second side surface
2e first end face
2f second end face
3 first internal electrode
31 first portion
31a first extension
31b second extension
31c first inspection extension
31d first capacitance portion
31e fifth extension
31f sixth extension
32 first dummy portion
32a first dummy extension
32b second dummy extension
32c fifth dummy extension
32d sixth dummy extension
4 second internal electrode
41 second portion
41a third extension
41b fourth extension
41c second inspection extension
41d second capacitance portion
41e seventh extension
41f eighth extension
42 second dummy portion
42a third dummy extension
42b fourth dummy extension
42c seventh dummy extension
42d eighth dummy extension
5 dielectric layer
6 side cover
7, 8 external electrode
7a first external electrode
7b third external electrode
7c fifth external electrode
7d seventh external electrode
8a second external electrode
8b fourth external electrode
8c sixth external electrode
8d eighth external electrode
9 inspection electrode
9a first inspection electrode
9b second inspection electrode
10 substrate
10a mounting surface
11a first substrate electrode
11b second substrate electrode
12 conductive bond
100 mounting structure

1. A multilayer ceramic capacitor, comprising:
a body being substantially rectangular and including a first internal electrode and a second internal electrode alternately stacked in a first direction with a dielectric layer between the first internal electrode and the second internal electrode, the body including a first surface and a second surface facing each other, a first side surface and a second side surface facing each other in the first direction, and a first end face and a second end face facing each other;
a first external electrode and a second external electrode located on the first surface;
a third external electrode and a fourth external electrode located on the second surface; and
a first inspection electrode located on the first end face and a second inspection electrode located on the second end face,
wherein the first internal electrode includes a first portion including a first extension, a second extension, and a first inspection extension,
the second internal electrode includes a second portion including a third extension, a fourth extension, and a second inspection extension,
the first extension extends to the first surface and is connected to the first external electrode, and the second extension extends to the second surface and is connected to the third external electrode,
the third extension extends to the first surface and is connected to the second external electrode, and the fourth extension extends to the second surface and is connected to the fourth external electrode, and
the first inspection extension extends to the first end face and is connected to the first inspection electrode, and the second inspection extension extends to the second end face and is connected to the second inspection electrode.

2. The multilayer ceramic capacitor according to claim 1, wherein
the first internal electrode further includes a first dummy portion electrically isolated from the first portion,
the second internal electrode further includes a second dummy portion electrically isolated from the second portion,
the first dummy portion includes a first dummy extension extending to the first surface and a second dummy extension extending to the second surface,
the second dummy portion further includes a third dummy extension extending to the first surface and a fourth dummy extension extending to the second surface,
the first dummy extension is connected to the second external electrode, and the second dummy extension is connected to the fourth external electrode, and
the third dummy extension is connected to the first external electrode, and the fourth dummy extension is connected to the second external electrode.

3. The multilayer ceramic capacitor according to claim 2, wherein
when viewed in a direction perpendicular to the first side surface, the first extension and the third dummy extension overlap, and the second extension and the fourth dummy extension overlap.

4. The multilayer ceramic capacitor according to claim 2 or claim 3, wherein
when viewed in a direction perpendicular to the first side surface, the third extension and the first dummy extension overlap, and the fourth extension and the second dummy extension overlap.

5. The multilayer ceramic capacitor according to any one of claims 1 to 4, wherein
the first external electrode and the third external electrode are located adjacent to the first end face, and the second external electrode and the fourth external electrode are located adjacent to the second end face.

6. The multilayer ceramic capacitor according to any one of claims 1 to 5, wherein
when viewed in a direction perpendicular to the first side surface, the first external electrode and the third external electrode overlap, and the second external electrode and the fourth external electrode overlap.

7. The multilayer ceramic capacitor according to any one of claims 1 to 6, wherein
the first inspection electrode and the second inspection electrode each have, in a direction perpendicular to the first surface, a dimension of 30 to 90% inclusive of a distance between the first surface and the second surface.

8. A multilayer ceramic capacitor mounting structure, comprising:
the multilayer ceramic capacitor according to any one of claims 1 to 7; and
a substrate including a mounting surface,
wherein the multilayer ceramic capacitor is mounted on the mounting surface with the first side surface perpendicular to the mounting surface.

9. The multilayer ceramic capacitor mounting structure according to claim 8, wherein
the substrate includes a first substrate electrode and a second substrate electrode located on the mounting surface, and
the first external electrode in the multilayer ceramic capacitor is bonded to the first substrate electrode with a conductive bond, and the second external electrode in the multilayer ceramic capacitor is bonded to the second substrate electrode with a conductive bond.
